(19) United States
(12) Patent Application Publication
(10) Pub. No.: US 2016/0265562 A1
(43) Pub. Date: Sep. 15, 2016

(54) HYDRAULIC CYLINDER OF MACHINES

(71) Applicant: Caterpillar Inc., Peoria, IL (US)

(72) Inventors: Jill E. Bailey, Moweaqua, IL (US); Michael R. Kunde, Decatur, IL (US); Veerabhadrarao Madireddi, Decatur, IL (US); Ross G. Nicholson, Keilor East (AU); Ethan M. Tevis, Bloomington, IL (US)

(73) Assignee: Caterpillar Inc., Peoria, IL (US)

(21) Appl. No.: 15/160,042

(22) Filed: May 20, 2016

(51) Int. Cl. F15B 15/14; F15B 15/24

(52) U.S. Cl. CPC F15B 15/1428; F15B 15/24; B60Y 2200/411; B60Y 2400/406

(57) ABSTRACT

A hydraulic cylinder assembly having a first portion connected to a first bar. A rod is constrained within a cylindrical recess by a first end and a second end of housing. A maximum travel of a first end of the rod within the housing defines a stroke of the hydraulic cylinder assembly. At least two structures are coupled with each other along a first edge and a second edge to form a space therewithin. A second surface of the structures having a first profile being at a first predetermined distance, and a second profile being at a second predetermined distance, from an axis of each of the at least two structures. The second predetermined distance is greater than the first predetermined distance. The structures are mounted over rod proximate to second end of rod to form a collar for limiting the stroke of the hydraulic cylinder assembly of a machine.

### TECHNICAL FIELD

The present disclosure relates to a hydraulic cylinder of a machine, and more specifically, to limiting a stroke of the hydraulic cylinder of the machine.

### BACKGROUND

Hydraulic cylinders are used in a number of machines such as, but not limited to, a motor grader, an excavator, a backhoe loader, a bulldozer, and a crawler. Typically, the hydraulic cylinders are coupled to a tool of the machines and are used for various operations such as for lifting, pulling, or pushing the tool. For example, a machine such as a motor grader includes a blade assembly coupled to a pair of hydraulic cylinders through a drawbar. During an operation or transportation of the motor grader, the blade assembly is required to be pulled close to a front frame of the machine by retraction of the hydraulic cylinders.

During the retraction of the hydraulic cylinders, an operator may retract the hydraulic cylinders until a hard stop is encountered. The hard stop is encountered due to a contact of a ball stud with the hydraulic cylinders, and the drawbar with a link bar. During the hard stop, the impact force causes stress in the drawbar, the link bar, and the ball stud, leading to a crack in welds, and thus decreasing the lifespan of the hydraulic cylinders, the drawbar and the link bar of the machine. Therefore, there is a need for an improved hydraulic cylinder assembly in order to prevent stress, and the damage to the hydraulic cylinders, and other components such as the drawbar, the link bar, and the ball stud of the machine.

U.S. Pat. No. 7,610,845 discloses a stop assembly for limiting stroke of a cylinder. The stop assembly has a clamping ring and a threaded section on its outer circumference, and a threaded ring, which is screwed onto the threaded section of the clamping ring. The clamping ring and the threaded ring are split in two ring halves of the clamping ring which are adapted to couple with each other by screws or fasteners, and being clamped on a piston rod. However, the stop assembly fails to provide any solution for the damage caused by a stop assembly to itself and different parts of a machine during the retraction of the cylinder. Therefore, there is a need for an improved stop assembly for hydraulic cylinders of the machine.

### SUMMARY OF THE DISCLOSURE

In one aspect of the present disclosure, a hydraulic cylinder assembly of a machine is provided. The hydraulic cylinder assembly includes a housing having a cylindrical recess, a first end, a first portion, and a second end. The first portion being connected to a first bar of the machine. A rod is constrained within the cylindrical recess by the first end and the second end of the housing. The rod having a first end adapted to movably slide within the cylindrical recess. A maximum travel of the first end of the rod within the housing is adapted to define a stroke of the hydraulic cylinder assembly. The rod having a second end which is connected to a socket of the machine. At least two structures, each having a first edge and a second edge. The at least two structures are adapted to couple with each other along the first edge and the second edge of each of the at least two structures, to form a space therewithin. The space being of a predefined shape, and is same as a first surface of the rod. Each one of the at least two structures including a second surface having a first profile being at a first predetermined distance from an axis of each one of the at least two structures. A second profile being at a second predetermined distance from the axis of each one of the at least two structures, the second profile adapted to accommodate a portion of the socket. The second predetermined distance is greater than the first predetermined distance. The at least two structures are adapted to mount over the rod of the machine proximate to the second end of the rod to form a collar for limiting the stroke of the hydraulic cylinder assembly of the machine.

### BRIEF DESCRIPTION OF THE DRAWINGS

FIG. 1 shows a pictorial view of an exemplary machine, in accordance with the concepts of the present disclosure;

FIG. 2 shows an enlarged view of a hydraulic cylinder assembly of the machine of FIG. 1, in accordance with the concepts of the present disclosure;

FIG. 3 shows a sectional view of the hydraulic cylinder assembly of FIG. 2 taken along 3-3′, in accordance with the concepts of the present disclosure;

FIG. 4 shows an exploded view of a portion of the hydraulic cylinder assembly of the machine of FIG. 1 illustrating at least two structures, a socket, a plurality of clamps, and a ball stud, in accordance with the concepts of the present disclosure;

FIGS. 5A, 5B shows a pictorial view of a collar, and a side view of the collar, respectively, in accordance with the concepts of the present disclosure; and

FIGS. 6A, 6B shows a pictorial view of an alternate embodiment of a collar, and a sectional view of FIG. 6A taken along 6-6′ of the alternate embodiment of the collar, respectively, in accordance with the concepts of the present disclosure.

### DETAILED DESCRIPTION

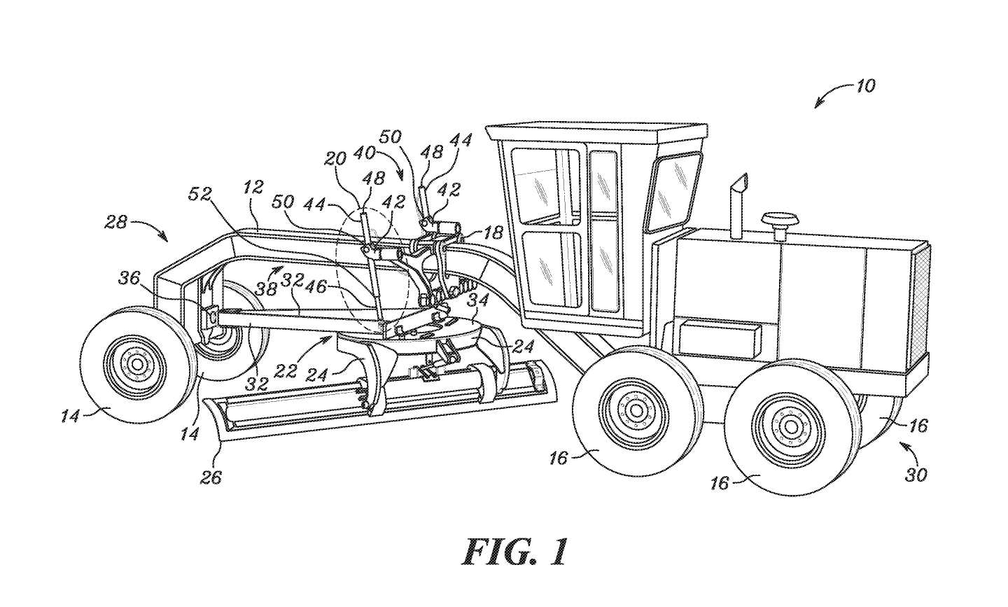

Referring to FIG. 1, a machine 10 includes a first frame 12 (i.e., a main frame), a number of first wheels 14, a number of second wheels 16, a first bar 18 (i.e., a link bar), a hydraulic cylinder assembly 20, a second bar 22 (i.e., a drawbar), a blade support frame 24, and a blade 26. The machine 10 further includes a number of various other components such as, but not limited to, engine housing, or an operator's cabin. For the purpose of simplicity, the various other components of the machine 10 are not labeled in FIG. 1. It will be apparent to one skilled in the art that the machine 10 shown in FIG. 1 is a motor grader machine. However, the machine 10 may be any other machine including, but not limited to, an excavator, a backhoe loader, or a bulldozer, without departing from the scope of the disclosure. The machine 10 is used for a variety of operations such as, but not limited to, surface leveling, or land grading.

The machine 10 having a first end 28 (i.e., a front end) of the machine 10 and a second end 30 (i.e., a rear end) of the machine 10. The first frame 12 is coupled to the first bar 18. The first bar 18 is further coupled to the second bar 22 which includes a first frame portion 32 (i.e., a circular frame portion) and a second frame portion 34 (i.e., a triangular frame portion). The first frame portion 32 is coupled to the second frame portion 34. As an example, the first frame portion 32 is coupled to the second frame portion 34 using weld joints. The second frame portion 34 is further coupled to the first frame 12 at a first end 36 of the second bar 22.

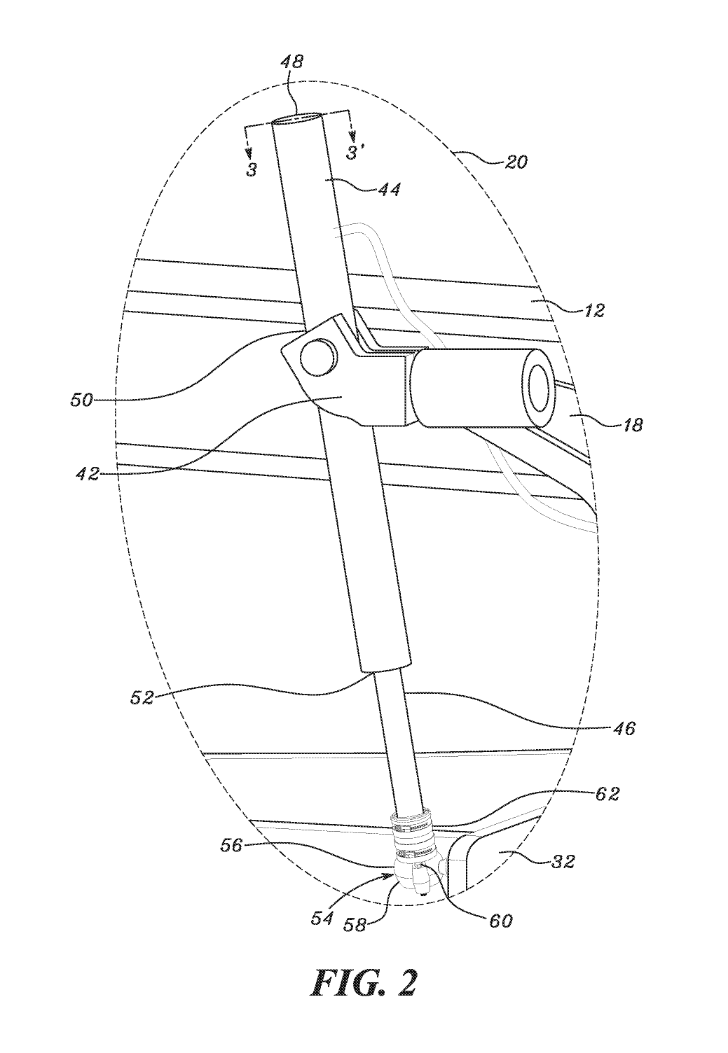

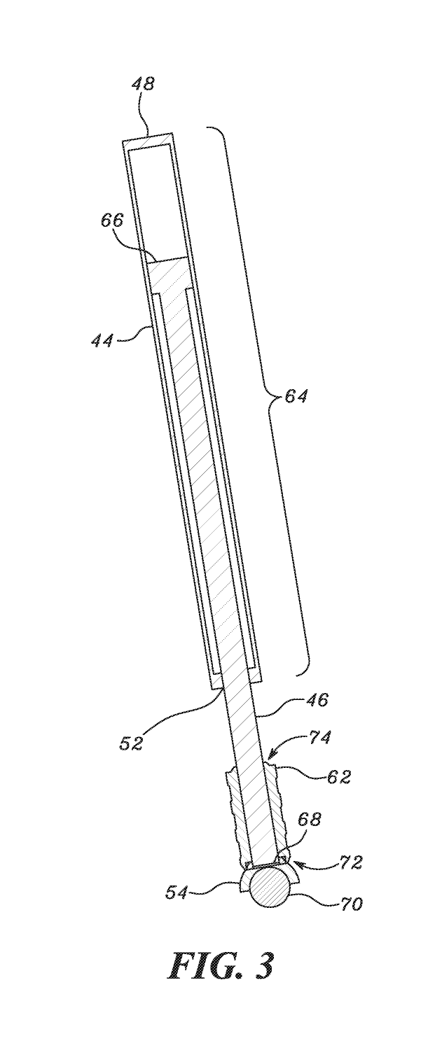

Further, the first frame portion 32 is coupled to the blade support frame 24 using, but not limited to, fasteners. The blade support frame 24 is further coupled to the blade 26. During an operation or transportation of the machine 10, the blade 26 is required to be lifted, which is achieved using the hydraulic cylinder assembly 20. The hydraulic cylinder assembly 20 is provided on both sides (i.e., a first side 38 and a second side 40) of the first frame 12 of the machine 10, and is coupled to the first bar 18 via a joint 42 (i,e, a yoke joint). The hydraulic cylinder assembly 20 of the machine 10 includes a housing 44, and a rod 46. The housing 44 having a first end 48, a first portion 50, and a second end 52. The detailed description of the hydraulic cylinder assembly 20 is described later in conjunction with FIGS. 2 and 3.

Referring to FIGS. 2 and 3, the housing 44 of the hydraulic cylinder assembly 20, having a cylindrical recess 64 (shown in FIG. 3). Further, the hydraulic cylinder assembly 20 having the rod 46 which is constrained within the cylindrical recess 64 by the first end 48 of the housing 44 and the second end 52 of the housing 44. The rod 46 further having a first end 66 (shown in FIG. 3) and a second end 68 (shown in FIG. 3). The first end 66 of the rod 46 is adapted to movably slide within the cylindrical recess 64. It should be noted that a maximum travel of the first end 66 of the rod 46 within the housing 44 is adapted to define a stroke of the hydraulic cylinder assembly 20.

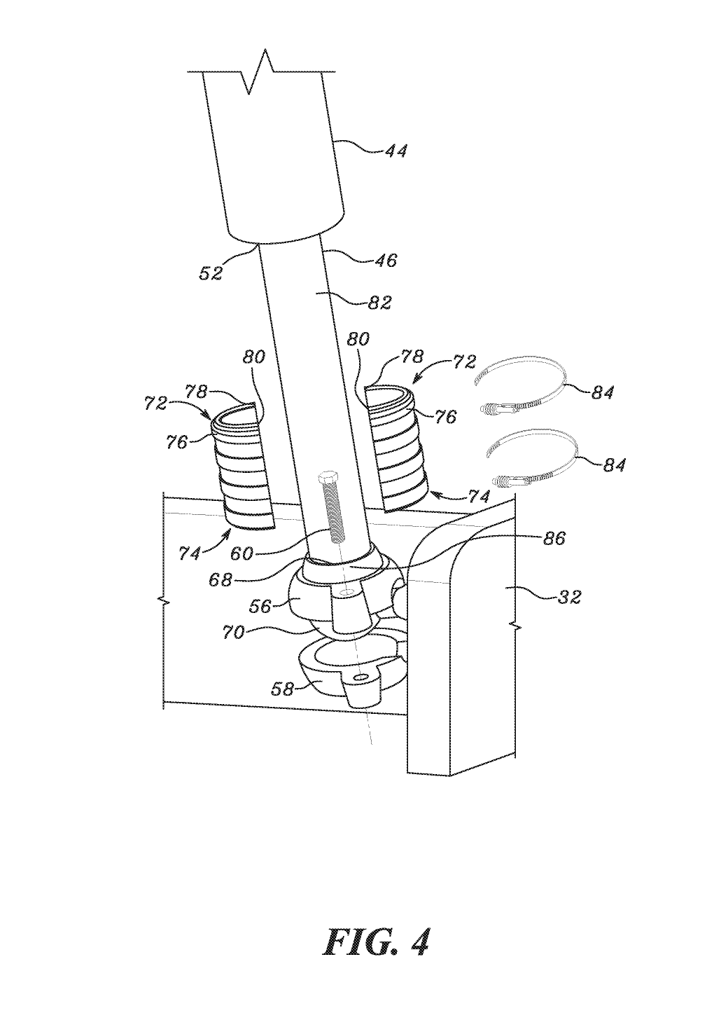

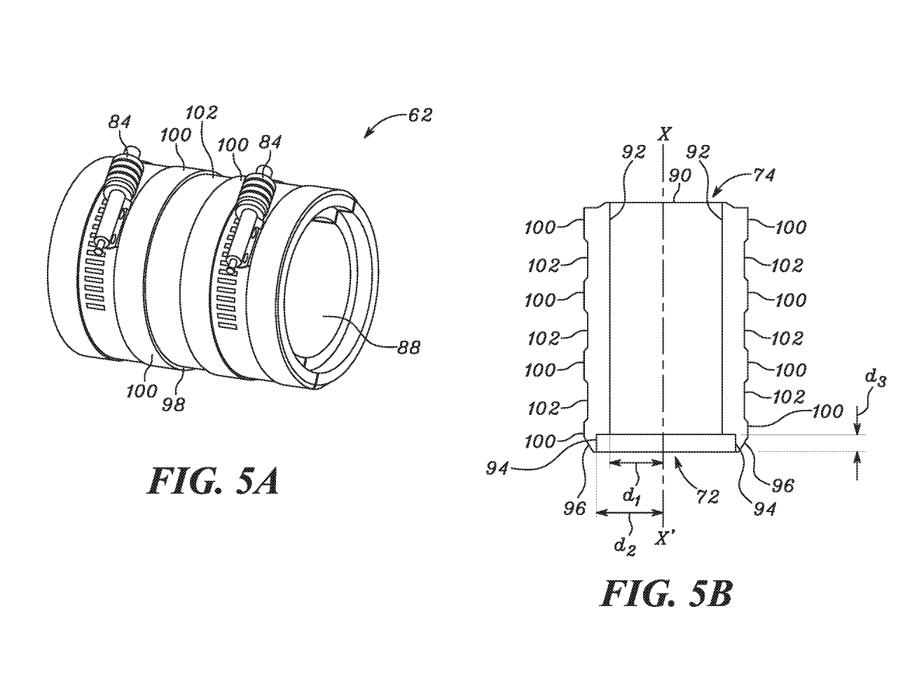

Further, the second end 68 (shown in FIG. 3) of the rod 46 is coupled to a socket 54 of the machine 10. The socket 54 having an upper member 56 (shown in FIG. 2) and a lower member 58 (shown in FIG. 2). The upper member 56 and the lower member 58 are fastened with each other through fasteners 60. The upper member 56 of the socket 54 is welded with the rod 46. Further, a ball stud 70 (shown in FIG. 3) is coupled to the first frame portion 32 of the second bar 22, and included within the socket 54. The hydraulic cylinder assembly 20 further has a collar 62 which is mounted over the rod 46 proximate to the second end 68 (shown in FIG. 3) of the rod 46, for limiting the stroke of the hydraulic cylinder assembly 20 of the machine 10. The collar 62 having a first end 72 (shown in FIG. 3) and a second end 74 (shown in FIG. 3). The detailed description of the collar 62 is described later in conjunction with FIGS. 4 and 5.

Referring to FIGS. 4 and 5, the hydraulic cylinder assembly 20 includes at least two structures 76. Each of the at least two structures 76 having a first edge 78 and a second edge 80. Further, the at least two structures 76 are adapted to couple with each other along the first edge 78 and the second edge 80 of each of the at least two structures 76 to form a space 88 (shown in FIG. 5) therewithin. The space 88 (shown in FIG. 5) being of a predefined shape, which is same as a first surface 82 (shown in FIG. 4) of the rod 46 (shown in FIG. 4). As an example, the predefined shape is a cylindrical shape. Further, the at least two structures 76 are adapted to mount over the rod 46 proximate to the second end 68 of the rod 46 using a number of clamps 84 (i.e., a number of band clamps).

Each of the at least two structures 76 having a second surface 90 (shown in FIG. 5) The second surface 90 having a first profile 92 (i.e., a straight profile), and a second profile 94 (i.e., a step profile). The first profile 92 of the second surface 90 is at a first predetermined distance d₁ from an axis X-X′ of each one of the at least two structures 76. On the other hand, the second profile 94 is at a second predetermined distance d₂ from the axis X-X′ of each one of the at least two structures 76. Further, the second profile 94 is disposed at the first end 72 of each of the at least two structures 76 of the collar 62, and extends a predetermined distance d₃ parallel to the axis X-X′ of each of the at least two structures 76. The second profile 94 is further adapted to accommodate a portion 86 (shown in FIG. 4) of the socket 54 (shown in FIG. 4). It should be noted that the second predetermined distance d₂ is greater than the first predetermined distance d₁. Further, the at least two structures 76 having a chamfer portion 96 at the first end 72 of each one of the at least two structures 76 of the collar 62. Each of the at least two structures 76 of the collar 62 further having a third surface 98 (i.e., an outer surface) which has a number of protrusions 100 and a number of depressions 102. The depressions 102 are adapted to hold the clamps 84 (i.e., the band clamps) for fastening the at least two structures 76 with each other to form the collar 62. It will be apparent to one skilled in the art that the third surface 98 (i.e., the outer surface) mentioned herein may have any other patterns for holding the clamps 84, without departing from the scope of the disclosure.

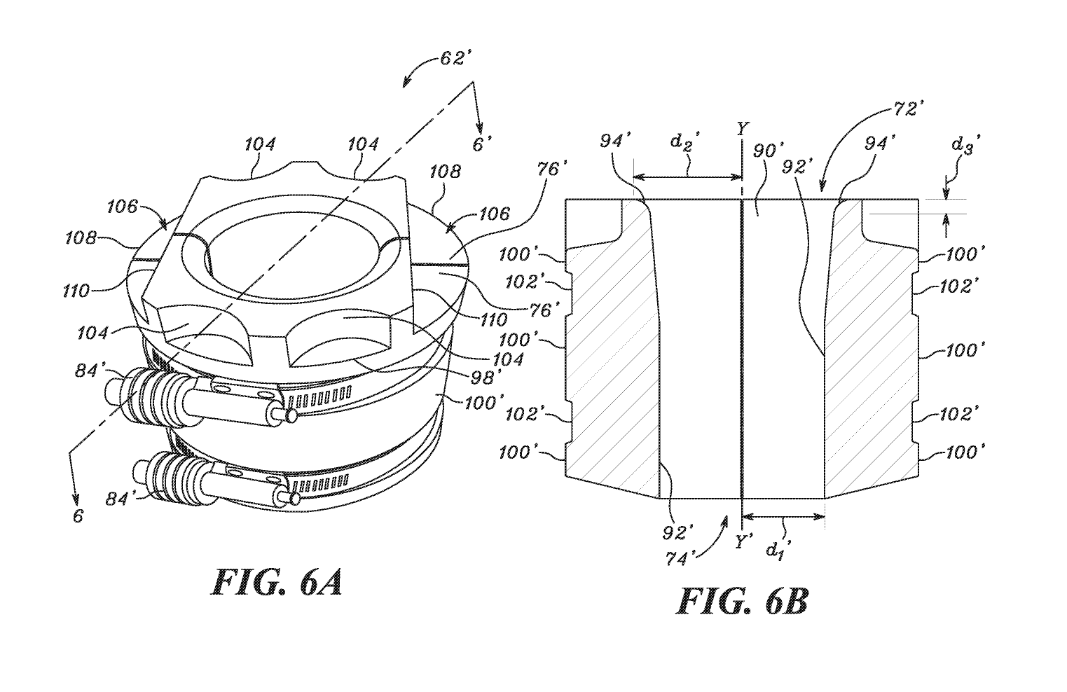

Referring to FIG. 6, an alternate embodiment of a collar 62′ is disclosed. The collar 62′ having a first end 72′, a second end 74′, and at least two structures 76′. The at least two structures 76′ including a second surface 90′. The second surface 90′ having a first profile 92′ and a second profile 94′. The first profile 92′ of the second surface 90′ is at a first predetermined distance d₁′ from an axis Y-Y′ of each one of the at least two structures 76′. On the other hand, the second profile 94′ is at a second predetermined distance d₂′ from the axis Y-N″ of each one of the at least two structures 76′. Further, the second profile 94′ is disposed at the first end 72′ of each of the at least two structures 76′ of the collar 62′, and extends a predetermined distance d₃′ parallel to the axis Y-Y′ of each of the at least two structures 76′. The second profile 94′ is adapted to accommodate the portion 86 (shown in FIG. 4) of the socket 54 (shown in FIG. 4). It should be noted that the second predetermined distance d₂′ is greater than the first predetermined distance d₁′.

Further, the collar 62′ having a third surface 98 (i.e., an outer surface) which has a number of protrusions 100′ and a number of depressions 102′. The depressions 102′ are configured to hold a number of clamps 84′ (i.e., a number of band clamps) for fastening the at least two structures 76′ with each other to form the collar 62′. Each of the at least two structures 76′ includes a number of recesses 104 at the first end 72′ of each of the at least two structures 76′. The recesses 104 are adapted to accommodate the fasteners 60 (shown in FIG. 4). Further, each of the at least two structures 76′ includes a number of portions 106 (i.e., a number of sliced portions). The portions 106 include a first member 108 and a second member 110. The first member 108 and the second member 110 are disposed at a predefined angle with respect to each other.

It will be apparent to one skilled in the art that the recesses 104 and the portions 106 mentioned herein may have any other patterns, without departing from the scope of the disclosure. Further, it should be noted that the at least two structures 76, and 76′ mentioned above are made up of non-metallic materials such as, but not limited to, plastic, polymer, or composite materials such as, but not limited to, reinforced plastics. Additionally, it should be noted that the second predetermined distance d₂ is smaller than the first predetermined distance d₁. Similarly, the second predetermined distance d₂′ is smaller than the first predetermined distance d₁′.

### INDUSTRIAL APPLICABILITY

The present disclosure provides the hydraulic cylinder assembly 20 of the machine 10. The hydraulic cylinder assembly 20 discloses the at least two structures 76 which are adapted to mount over the rod 46 proximate to the second end 68 of the rod 46 to form the collar 62. The collar 62 limits the stroke of the hydraulic cylinder assembly 20, which prevents contact between various components example, the first bar 18, the second bar 22, the housing 44 of the hydraulic cylinder assembly 20, and the ball stud 70) of the machine 10 during the retraction of hydraulic cylinders. This, in turn, extends the life span of the components. The second surface 90 has the second profile 94 to accommodate the portion 86 of the socket 54, in turn enabling a proper placement of the collar 62 over the socket 54. Further, the collar 62 is manufactured using non-metallic material which prevents wear caused to the first surface 82 of the rod 46, and also makes the collar 62 light in weight. Also, the collar 62 is designed in form of the at least two structures 76, which makes the collar 62 easy to assemble.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A hydraulic cylinder assembly of a machine, the hydraulic cylinder assembly comprising:
a housing having a cylindrical recess, a first end, a first portion, and a second end, the first portion being connected to a first bar of the machine;
a rod is constrained within the cylindrical recess by the first end and the second end of the housing, the rod having:
a first end adapted to movably slide within the cylindrical recess, wherein a maximum travel of the first end of the rod within the housing is adapted to define a stroke of the hydraulic cylinder assembly; and
a second end connected to a socket of the machine; and
at least two structures, each having a first edge and a second edge, the at least two structures adapted to couple with each other along the first edge and the second edge of each of the at least two structures to form a space therewithin, the space being of a predefined shape, and is same as a first surface of the rod, each one of the at least two structures including:
a second surface having:
a first profile of the second surface being at a first predetermined distance from an axis of each one of the at least two structures; and
a second profile being at a second predetermined distance from the axis of each one of the at least two structures, the second profile adapted to accommodate a portion of the socket;
wherein the second predetermined distance is greater than the first predetermined distance;
wherein the at least two structures are adapted to mount over the rod of the machine proximate to the second end of the rod to form a collar for limiting the stroke of the hydraulic cylinder assembly of the machine.
